(19) United States
(12) Patent Application Publication
(10) Pub. No.: US 2025/0231297 A1
(43) Pub. Date: Jul. 17, 2025

(54) FREQUENCY MODULATED CONTINUOUS WAVE LASER RADAR RANGING AND SPEED MEASURING SYSTEM AND METHOD

(71) Applicant: SILITH TECHNOLOGY PTE. LTD., SINGAPORE (SG)

(72) Inventors: Rui ZHU, Shanghai (CN); Guangzhu ZHOU, Shanghai (CN); Ke ZHANG, Shanghai (CN)

(73) Assignee: SILITH TECHNOLOGY PTE. LTD., SINGAPORE (SG)

(21) Appl. No.: 18/926,314

(22) Filed: Oct. 25, 2024

(30) Foreign Application Priority Data
Jan. 17, 2024 (CN) 202410063219.X

(51) Int. Cl. G01S 17/34; G01S 7/48; G01S 7/481; G01S 7/4913; G01S 17/58

(52) U.S. Cl. CPC G01S 17/34; G01S 7/4802; G01S 7/4811; G01S 7/4815; G01S 7/4913; G01S 17/58

(57) ABSTRACT

A frequency-modulated system includes a signal generation module providing a first laser signal, a second laser signal, a third laser signal and a fourth laser signal with different frequencies to form an input laser signal in a first polarization state; the silicon optical chip divides an input laser signal into a detection signal and a local oscillator signal, receives a reflection signal component in a second polarization state as an echo signal, converts the reflection signal component into a first polarization state, and mixes the reflection signal component with the local oscillator signal; and the signal processing module performs decoupling according to the beat frequency signal to obtain distance information and instantaneous speed information of the target object. According to the disclosure, the dot frequency is improved, and smaller detection resolution is realized point frequencies in each frame and detection resolution are improved.

### CROSS-REFERENCES TO RELATED APPLICATION

The present application claims the priority benefit of China Application serial No. 202410063219.X, filed on Jan. 17, 2024. The entirety of the above-mentioned patent application is hereby incorporated by reference herein and made a part of this specification.

### BACKGROUND

### Technical Field

The present application relates to the technical field of laser radars, and in particular, to a frequency-modulated continuous-wave (FMCW) laser radar ranging and speed measuring system and method.

### Description of Related Art

A frequency-modulated continuous-wave (FMCW) laser radar is able to implement both ranging and speed measurement simultaneously, having been widely used in an autonomous driving system or an auxiliary driving system. Compared with a plurality of other detection schemes, including Time of Flight (TOF), the FMCW laser radar has a plurality of advantages including a transmit power required being small, a signal-to-noise ratio being high, and more.

An FMCW radar system generally divides a signal having been modulated by a linear frequency into two paths, one path serves as a local oscillation signal, another path serves as a detection signal, then a detection signal being transmitted is reflected by a target object, that is, an object to be detected, before forming an echo signal, the echo signal is then having a frequency mixed with the local oscillation signal to generate a beat frequency signal. During a detection process, a distance of the target object will generate a frequency shift, called a ranging frequency shift (f_{R}), while a radial speed of the target object will also generate a frequency shift between two signals stated above, called a Doppler frequency shift (f_{D}). For a modulation signal of triangular wave, when a target object is moving at a certain speed, a beat frequency signal of the echo signal and the local oscillation signal being detected will generate two signals Δf₁ and Δf₂ in a frequency domain at a frequency rising edge and a frequency falling edge, while mixing with a plurality of information including f_{R} and f_{D}. Based on a plurality of different cases discussed below, f_{R} and f_{D} have different expressions:
(1) When the target object is stationary, Δf₁=Δf₂=f_{R}, f_{D}=0;
(2) In a general case (f_{R}>f_{D}), when the target object is approaching, Δf₁Δf₂, then:

$${f}_{R} = ( Δ {f}_{1} + Δ {f}_{2} ) / 2 , {f}_{D} = ( Δ {f}_{2} - Δ {f}_{1} ) / 2 ;$$

(3) In a general case (f_{R}>f_{D}), when the target object is moving away, Δf₁>Δf₂, then:

$${f}_{R} = ( Δ {f}_{1} + Δ {f}_{2} ) / 2 , {f}_{D} = ( Δ {f}_{1} - Δ {f}_{2} ) / 2 ;$$

(4) In a special case, such as a short-range high-speed motion (f_{R}<f_{D}), when the target object is approaching, Δf₁<Δf₂, then:

$${f}_{R} = ( Δ {f}_{2} - Δ {f}_{1} ) / 2 , {f}_{D} = ( Δ {f}_{2} + Δ {f}_{1} ) / 2 ;$$

(5) In a special case, such as a short-range high-speed motion (f_{R}<f_{D}), when the target object is moving away, Δf₁>Δf₂, then:

$${f}_{R} = ( Δ {f}_{1} - Δ {f}_{2} ) / 2 , {F}_{D} = ( Δ {f}_{1} + Δ {f}_{2} ) / 2 .$$

Therefore, based on a plurality of complex situations stated above, a traditional scheme of triangular wave internal modulation cannot solve a hybrid problem in a special case of mixing a ranging frequency shift and the Doppler frequency shift, a general FMCW laser radar system is hard to distinguish the F_{R} and the F_{D} completely, and in a triangular wave period, only a point can be generated in a point cloud, resulting in a low point frequency.

In an existing double-sideband modulation method, a Mach-Zehnder modulator is configured to implement a double-sideband frequency-modulated continuous wave signal, so as to realize decoupling and acquisition of both distance and speed information. However, an effective energy of a double-sideband modulation based on a phase modulator scheme is relatively low, thus, a filtering module and an amplification module shall be added additionally after modulation, that makes a system architecture relatively complex, and causing a problem of a frequency modulation bandwidth being limited to a certain extent.

### SUMMARY

An object of the present invention is to overcome the above-mentioned defects in the prior art, and to provide a frequency-modulated continuous-wave laser radar ranging and speed measuring system and method.

In order to achieve the objectives mentioned above, the technical solution of the present application is as follows:

The present invention provides a frequency-modulated continuous-wave laser radar ranging and speed measuring system, wherein comprising:
a signal generation module, configured to provide an input laser signal in a first polarization state composed of a first laser signal, a second laser signal, a third laser signal and a fourth laser signal with different frequencies, wherein the first laser signal has a fixed frequency, the second laser signal is subjected by frequency modulation, the third laser signal and the fourth laser signal are generated based on the first laser signal and the second laser signal, both a frequency of the third laser signal and a frequency of the fourth laser signal have a corresponding relationship with a frequency of the first laser signal and a frequency of the second laser signal respectively, and an optical power of the first laser signal is different from an optical power of the second laser signal;
a silicon optical chip, configured to divide the input laser signal into a detection signal and a local oscillation signal, send out the detection signal, and receive an echo signal of a reflected signal component in a second polarization state orthogonal to a first polarization state in the reflected signal of the target object, then convert the echo signal in the second polarization state into the echo signal in the first polarization state, followed by performing a frequency mixing with the local oscillation signal to generate a beat frequency signal;
a signal processing module, configured to perform decoupling according to the beat frequency signal to obtain both distance information and instantaneous speed information of the target object.

Further, the signal generation module comprises a light source module, an optical amplification module and a nonlinear medium module, wherein the light source module is configured to transmit the first laser signal and the second laser signal with different frequencies, the first laser signal has a first frequency fixed to a first initial frequency without modulation, the second laser signal has a second frequency generated by performing a linear sawtooth wave frequency modulation onto a second initial frequency, the optical amplification module is configured to amplify the first laser signal and the second laser signal before inputting into the nonlinear medium module, while ensuring an optical power of the first laser signal having been amplified less than that of the second laser signal having been amplified; the nonlinear medium module is configured to make the first laser signal and the second laser signal have an interaction happened, and generating a third laser signal having a third frequency and a fourth laser signal having a fourth frequency based on a four-wave mixing (FWM) effect, so as to form the input laser signal before coupling to the silicon optical chip; wherein the third frequency has a first correspondence with the first frequency and the second frequency, while the fourth frequency has a second correspondence with the first frequency and the second frequency.

Further comprising: a trans-impedance amplification (TIA) module; the silicon optical chip comprises a light splitting unit, a transceiving antenna unit, a polarization separation unit, a polarization rotation unit, an optical frequency mixing unit, and a photoelectric detection unit; the light splitting unit is configured to divide the input laser signal being coupled to the silicon optical chip into the detection signal and the local oscillation signal, then input respectively to the polarization separation unit and the optical frequency mixing unit, while ensuing a beam splitting ratio of the detection signal larger than that of the local oscillation signal; the transceiving antenna unit is configured to send the detection signal coming from the polarization separation unit out to a free space, and receive the echo signal reflected from the target object; the polarization separation unit is configured to separate the detection signal and the echo signal; the polarization rotation unit is configured to convert the echo signal in the second polarization state coming from the polarization separation unit into the echo signal in the first polarization state, so that both the echo signal and the local oscillation signal have same of the first polarization state, the optical mixing unit is configured to mix the echo signal coming from the polarization rotation unit with the local oscillation signal, input the four of the beat frequency signals being generated to the photoelectric detection unit to further obtain a beat frequency current signal; and the TIA module is configured to further convert the beat frequency current signal having been input into a beat frequency voltage signal having been amplified, and input into the signal processing module for decoupling, so as to obtain the distance information and the instantaneous speed information of the target object.

Further, the signal processing module generates correspondingly a spectrum signal containing at most four signal peaks according to the beat frequency voltage signal, analyzes and determines a correspondence between an amount of the signal peaks and a signal intensity of each of the signal peaks, so as to realize decoupling the distance and the speed of the target object in any cases.

Further, when an amount of the signal peaks is two, the signal processing module determines that the target object is in a static state, and when the amount of the signal peaks is four, the signal processing module determines that the target object is in a motion state, and further determines if the target object is moving closer or moving away, according to a correspondence between the signal intensities of the signal peaks; thus, according to a corresponding relationship between the frequency of each signal peak and the beat frequency signal when the target object is in a different state, a relationship between the Doppler frequency shift of the target object and the time of flight used for implementing distance measurement and speed measurement is obtained, so as to calculate the distance and the speed of the target object in any case.

Further, the light source module comprises a first laser and a second laser, the first laser is configured to generate a first initial laser signal with the first initial frequency in the first polarization state, so as to form the first laser signal with a first frequency having a same fixed frequency as the first initial laser signal; the second laser is configured to generate a second initial laser signal with a second initial frequency in the first polarization state, and performing a linear sawtooth wave frequency modulation onto the second initial laser signal to form a second laser signal with a second frequency having a modulated frequency different from the second initial laser signal; the optical amplification module comprises an optical fiber amplifier, configured to amplify the first laser signal coming from the first laser and the second laser signal coming from the second laser, before inputting into the non-linear medium module at a same time; the non-linear medium module comprises a non-linear optical fiber, the non-linear optical fiber is coupled to the silicon optical chip through an edge coupler or a lens, so as to couple the input laser signal to the silicon optical chip.

Further, the light splitting unit comprises an optical splitter; the transceiver antenna unit comprises a transceiver antenna and a collimating lens, the transceiver antenna comprises a grating antenna or an optical waveguide based end-fire antenna; or the transceiver antenna unit comprises an optical phased array; the polarization separation unit comprises a polarization separator; the polarization rotation unit comprises a polarization rotator; the optical mixing unit comprises an optical mixer; the photoelectric detection unit comprises a balanced photoelectric detector; and the trans-impedance amplification module comprises a trans-impedance amplifier.

Further, a difference between the optical power of the second laser signal and the optical power of the first laser signal is greater than 3 dB; and/or, the input laser signal is divided into the detection signal and the local oscillation signal according to a beam splitting ratio of 90:10; and/or a difference between the second initial frequency and the first initial frequency is greater than 10 GHz; and/or, the first polarization state comprises a TE polarization state, while the second polarization state comprises a TM polarization state.

The present application further provides a method of ranging and speed measurement for a frequency-modulated continuous-wave laser radar, comprising:
providing an input laser signal of a TE polarization state composed of a first laser signal, a second laser signal, a third laser signal and a fourth laser signal with different frequencies, wherein the first laser signal has a fixed frequency, the second laser signal is subjected by frequency modulation, the third laser signal and the fourth laser signal are generated based on the first laser signal and the second laser signal, both a frequency of the third laser signal and a frequency of the fourth laser signal have a corresponding relationship with a frequency of the first laser signal and a frequency of the second laser signal respectively, an optical power of the first laser signal is further different from an optical power of the second laser signal;
dividing the input laser signal into a detection signal and a local oscillation signal, sending out the detection signal, and receiving an echo signal of a reflected signal component in a second polarization state orthogonal to a first polarization state in the reflected signal of the target object, then converting the echo signal in the second polarization state into the echo signal in the first polarization state, followed by performing a frequency mixing with the local oscillation signal to generate a beat frequency signal;
performing decoupling according to the beat frequency signal to obtain both distance information and instantaneous speed information of the target object.

Further, forming the first laser signal of a first frequency f₁′ having a same fixed frequency as a first initial laser signal, by generating the first initial laser signal in the first polarization state having a first initial frequency f₁, and satisfying f₁′=f₁; forming the second laser signal of a second frequency f₂′ having a different modulated frequency according to a second initial laser signal, by generating the second initial laser signal in the first polarization state having a second initial frequency f₂, and by performing a frequency linear sawtooth modulation on the second initial laser signal, and satisfying: f₂′=f₂+εt, ε is a frequency modulation slope, t is time; by amplifying both the first laser signal and the second laser signal before inputting into a nonlinear optical fiber synchronously, and ensuring an optical power of the first laser signal having been amplified less than that of the second laser signal having been amplified, while making the first laser signal and the second laser signal have an interaction happened in the non-linear optical fiber, and generating a third laser signal having a third frequency f₃′ and a fourth laser signal having a fourth frequency f₄′ based on a four-wave mixing effect, so as to form the input laser signal; wherein the third frequency has a first correspondence with the first frequency and the second frequency, satisfying: f₃′=2f₁′−f₂′=2f₁−f₂−εt; while the fourth frequency has a second correspondence with the first frequency and the second frequency, satisfying: f₄′=2f₂′−f₁′=2f₂ f₁+2εt; when dividing the input laser signal into the detection signal and the local oscillation signal, a beam splitting ratio of the detection signal is greater than a beam splitting ratio of the local oscillation signal.

Further, generating four of the beat frequency signals by mixing the echo signal with the local oscillation signal; obtaining the beat frequency current signal by performing photoelectric conversion on the beat frequency signal; obtaining an amplified beat frequency voltage signal by amplifying and converting the beat frequency current signal; generate correspondingly a frequency spectrum signal containing at most four signal peaks by processing the beat frequency voltage signal; achieving decoupling the distance and the speed of the target object in any cases by analyzing and determining a correspondence between an amount of the signal peaks and a signal intensity of each signal peak.

Further, while analyzing and determining a correspondence between the amount of the signal peaks and the signal intensity of each signal peak, when an amount of the signal peaks is two, the target object is determined to be in a static state, and when the amount of the signal peaks is four, the target object is determined to be in a motion state, and further determines if the target object is moving closer or moving away, according to a correspondence between the signal intensities of each of the signal peaks; thus, according to a corresponding relationship between the frequency of each signal peak and the beat frequency signal when the target object is in a different state, a relationship between the Doppler frequency shift of the target object and the time of flight used for implementing distance measurement and speed measurement is obtained, so as to calculate the distance and the speed of the target object in any case.

Further, analyzing and determining a correspondence between the amount of the signal peaks and the signal intensity of each signal peak, further comprising:
defining four of the signal peaks according to a frequency value, fₐ<f_{b}<f_{c}<f_{d}, and defining four signal intensities Aₐ, A_{b}, A_{c}, A_{d} according to the four frequency values fₐ, f_{b}, f_{c}, and f_{d}, defining a time of flight (TOF) r used in measuring the distance and the speed, a ranging frequency shift f_{R}, and a Doppler frequency shift f_{D}; and performing decoupling according to 1)-5) below:
1) when the target object is in the static state, after the time t, a first echo frequency f₁″, a second echo frequency f₂″, a third echo frequency f₃″ and a fourth echo frequency f₄″ in the echo signal corresponding sequentially to the first frequency f₁′, the second frequency f₂′, the third frequency f₃′, and the fourth frequency f₄′, satisfying:

$${f}_{1}^{″} = {f}_{1} ,$$

$${f}_{2}^{″} = {f}_{2} + ε ( t - τ ) = {f}_{2} + ε t - ετ ,$$

$${f}_{3}^{″} = 2 {f}_{1} - {f}_{2} - ε ( t - τ ) = 2 {f}_{1} - {f}_{2} - ε t + ετ ,$$

$${f}_{4}^{″} = 2 {f}_{2} - {f}_{1} + 2 ε ( t - τ ) = 2 {f}_{2} - {f}_{1} + 2 ε t - 2 ετ ;$$

thus, the beat frequency signal generated after mixing with the f₁′, f₂′, f₃′ and f₄′ in the local oscillation signal is:

$$Δ {f}_{1} = 0 , Δ {f}_{2} = \vert - ετ \vert = {f}_{a} , Δ {f}_{3} = ε τ = {f}_{a} , Δ {f}_{4} = \vert - 2 ετ \vert = {f}_{d} ;$$

in such a state, two signal peaks fₐ and fₐ are generated in a spectrum and satisfying: τ=fₐ/ε, f_{d}=0;

2) in a regular distance, when the target object is moving closer, ετ>f_{D}, satisfying:

$${f}_{1}^{″} = {f}_{1} + {f}_{D} ,$$

$${f}_{2}^{″} = {f}_{2} + ε t - ε τ + {f}_{D} ,$$

$${f}_{3}^{″} = 2 {f}_{1} - {f}_{2} - ε t + ε τ + {f}_{D} ,$$

$${f}_{4} = 2 {f}_{2} - {f}_{1} + 2 ε t - 2 ε τ + {f}_{D} ;$$

$$Δ {f}_{1} = {f}_{D} , Δ {f}_{2} = ε τ - {f}_{D} , Δ {f}_{3} = ε τ + {f}_{D} , Δ {f}_{4} = 2 ε τ - {f}_{D} ;$$

when ετ>2f_{D}, satisfying:

$$Δ {f}_{1} = {f}_{D} = {f}_{a} , Δ {f}_{2} = ε τ - {f}_{D} = {f}_{b} , Δ {f}_{3} = ε τ + {f}_{D} = {f}_{c} , Δ {f}_{4} = 2 ε τ - {f}_{D} = {f}_{d} ;$$

when f_{D}<ετ<2f_{D}, satisfying:

$$Δ {f}_{1} = {f}_{D} = {f}_{b} , Δ {f}_{2} = ε τ - {f}_{D} = {f}_{a} , Δ {f}_{3} = ε τ + {f}_{D} = {f}_{d} , Δ {f}_{4} = 2 ε τ - {f}_{D} = {f}_{c} ;$$

3) in a short distance, when the target object is moving closer in a high speed, ετ<f_{D}, satisfying:

$$Δ {f}_{1} = {f}_{D} , Δ {f}_{2} = {f}_{D} - ετ , Δ {f}_{3} = ε τ + {f}_{D} , Δ {f}_{4} = \vert 2 ετ - {f}_{D} \vert ;$$

when ετ<½f_{D}, satisfying:

$$Δ {f}_{1} = {f}_{D} = {f}_{c} , Δ {f}_{2} = {f}_{D} - ε τ = {f}_{b} , Δ {f}_{3} = ε τ + {f}_{D} = {f}_{d} , Δ {f}_{4} = {f}_{D} - 2 ε τ = {f}_{a} ;$$

When ½f_{D}<ετ<⅔f_{D}, satisfying:

$$Δ {f}_{1} = {f}_{D} = {f}_{c} , Δ {f}_{2} = {f}_{D} - ε τ = {f}_{b} , Δ {f}_{3} = ε τ + {f}_{D} = {f}_{d} , Δ {f}_{4} = 2 ε τ - {f}_{D} = {f}_{a} ;$$

When ⅔f_{D}<ετ<f_{D}, satisfying:

$$Δ {f}_{1} = {f}_{D} = {f}_{c} , Δ {f}_{2} = {f}_{D} - ε τ = {f}_{a} , Δ {f}_{3} = ε τ + {f}_{D} = {f}_{d} , Δ {f}_{4} = 2 ε τ - {f}_{D} = {f}_{b} ;$$

4) in a regular distance, the target object is moving away, when ετ>f_{D}, satisfying:

$${f}_{1}^{″} = {f}_{1} - {f}_{D} ,$$

$${f}_{2}^{″} = {f}_{2} + ε t - ε τ - {f}_{D} ,$$

$${f}_{3}^{″} = 2 {f}_{1} - {f}_{2} - ε t + ε τ - {f}_{D} ,$$

$${f}_{4} = 2 {f}_{2} - {f}_{1} + 2 ε t - 2 ε τ - {f}_{D} ;$$

$$Δ {f}_{1} = {f}_{D} , Δ {f}_{2} = ε τ + {f}_{D} , Δ {f}_{3} = \vert ετ - {f}_{D} \vert , Δ {f}_{4} = 2 ε τ + {f}_{D} ;$$

when f_{D}<ετ<2f_{D}, satisfying:

$$Δ {f}_{1} = {f}_{D} = {f}_{b} , Δ {f}_{2} = {f}_{D} + ε τ = {f}_{c} , Δ {f}_{3} = ε τ - {f}_{D} = {f}_{a} , Δ {f}_{4} = {f}_{D} + 2 ε τ = {f}_{c} ;$$

when ετ>2f_{D}, satisfying:

$$Δ {f}_{1} = {f}_{D} = {f}_{a} , Δ {f}_{2} = {f}_{D} + ε τ = {f}_{c} , Δ {f}_{3} = ε τ - {f}_{D} = {f}_{b} , Δ {f}_{4} = {f}_{D} + 2 ε τ = {f}_{d} ;$$

5) in a short distance, when the target object is moving away in a high speed, ετ<f_{D}, satisfying:

$$Δ {f}_{1} = {f}_{D} = {f}_{b} , Δ {f}_{2} = {f}_{D} + ε τ = {f}_{c} , Δ {f}_{3} = {f}_{D} - ε τ = {f}_{a} , Δ {f}_{4} = {f}_{D} + 2 ε τ = {f}_{d} ;$$

according to the third laser signal and the fourth laser signal being generated based on the first laser signal and the second laser signal, the optical power of the first laser signal less than the optical power of the second laser signal, a power P_{f1} carried by the first frequency f₁′, a power P_{f2} carried by the second frequency f₂′, a power P_{f3} carried by the third frequency f₃′, and a power P_{f4} carried by the fourth frequency f₄′, have a relationship below:

$${P}_{f 2} > {P}_{f 1} > {P}_{f 3} , {P}_{f 2} > {P}_{f 1} > {P}_{f 4} ;$$

Thus, the signal intensities between Δf₁, Δf₂, Δf₃ and Δf₄ further satisfying:

$${A}_{Δ f 2} > {A}_{Δ f 1} > {A}_{Δ f 3} , {A}_{Δ f 2} > {A}_{Δ f 1} > {A}_{Δ f 4} ;$$

so as to obtain a relationship of magnitude between the signal intensities of Aₐ, A_{b}, A_{c}, and A_{d}, and obtain a result below:
when an amount of the signal peak is determined as two, the target object is determined in a static state, and according to 1), it obtains:

$${f}_{D} = 0 , τ = {f}_{a} / ε ;$$

when an amount of the signal peaks is determined as four, and A, is determined a maximum, the target object is determined to be moving away, according to 4) and 5), when it satisfies fₐ+f_{c}=2f_{b}, obtaining:

$${f}_{D} = {f}_{b} , τ = ( {f}_{c} - {f}_{b} ) / ε ;$$

when it is determined that fₐ+f_{c}=2f_{b} is not satisfied, obtaining:

$${f}_{D} = 2 {f}_{c} - {f}_{d} , τ = ( {f}_{d} - {f}_{c} ) / ε ;$$

when the amount of the signal peak is determined as four, and A_{c} is determined not the maximum, but A_{c}>Aₐ or A_{b}, the target object is determined to be moving closer, according to 2) and 3), obtaining:

$${f}_{D} = {f}_{c} , τ = ( {f}_{d} - {f}_{c} ) / ε ;$$

when the amount of the signal peak is determined as four, and A_{c} is determined not the maximum, while A_{c}>Aₐ or A_{b} is not satisfied, but Aₐ>A_{b} is satisfied, the target object is determined to be moving closer, according to 2) and 3), obtaining:

$${f}_{D} = {f}_{b} , τ = ( {f}_{a} - {f}_{b} ) / ε ;$$

when the amount of the signal peak is determined as four, and A_{c} is determined not the maximum, while A_{c}>Aₐ or A_{b} is not satisfied, and Aₐ>A_{b} is not satisfied either, the target object is determined to be moving closer; according to 2) and 3), obtaining:

$${f}_{D} = {f}_{a} , τ = ( {f}_{a} - {f}_{b} ) / ε ;$$

calculating and obtaining the distance and the speed of the target object according to the f_{D} and τ stated above, and outputting as a point cloud.

Further, when it is determined that the amount of the signal peaks is not four or two, a frequency spectrum at a next moment will be automatically re-sampled, until there are four or two signal peaks appearing in the frequency spectrum, then a second analysis and judgment process will be performed.

It can be seen from the technical solution stated above that, the present application generates an input laser signal having four different frequency signals (the first frequency to the fourth frequency), while making three of the frequencies (the second frequency to the fourth frequency) carry a frequency modulation signal (a linear sawtooth wave modulation signal), so that after the echo signal and the local oscillation signal are beaten and output, at most four signal peaks on the frequency spectrum can be obtained. Thus, by analysing and determining the correspondence between the amount of the signal peaks and the signal intensity of each of the signal peaks, it is possible to achieve decoupling calculation of the distance and the speed of the target object. Further, four different frequency signals are generated according to the FWM, so that a solution freedom degree is increased. Compared with the scheme of triangular wave internal modulation, the technical solution disclosed in the present application is possible to achieve decoupling the detection distance and the speed in any cases, and by adopting a frequency sweeping form of the linear sawtooth wave, a point frequency can be improved, thus, a problem in an existing FMCW internal modulation scheme has been effectively solved, including the ranging frequency shift and the Doppler frequency shift cannot be separated, and the point frequency is low in the triangular wave internal modulation scheme. In addition, the frequencies of two additional linear modulation generated by the FWM (the third frequency and the fourth frequency) have a larger frequency modulation bandwidth than an ordinary FMCW radar system and a FMCW radar system taking a double sideband modulation scheme, therefore a smaller detection resolution can be achieved.

### BRIEF DESCRIPTION OF THE DRAWINGS

FIG. 1 illustrates a schematic diagram on a four-wave mixing scheme adopted in a preferred embodiment of the present application;

FIG. 2 illustrates a structural block diagram on a frequency-modulated continuous-wave laser radar ranging and speed measuring system according to a preferred embodiment of the present application;

FIG. 3 illustrates a schematic diagram on a spectrum distribution that is possible to occur during a detection by a system according to a preferred embodiment of the present application;

FIG. 4 illustrates a flowchart on a determining process for decoupling the distance and the speed of a target object according to a preferred embodiment of the present application;

### DETAILED DESCRIPTION OF EMBODIMENTS

In order to make the purpose, technical solution and advantages of the present application clearer and more explicit, further detailed descriptions of the present application are stated here, referencing to the attached drawings and some embodiments of the present application. Obviously, the described embodiments are part of, but not all of, the embodiments of the present application. Based on the embodiments of the present application, all other embodiments obtained by those of ordinary skills in the art without any creative work are included in the scope of protection of the present application. Unless otherwise defined, technical or scientific terms used herein should have the meanings usually understood by those of ordinary skills in the art to which the present application belongs. As used herein, the terms “comprise” and the like are intended to mean that an element or item appearing before the term encompasses elements or items appearing after the term and the equivalents thereof, instead of excluding other elements or items.

In order to solve a problem that a ranging frequency shift and a Doppler frequency shift in an existing FMCW internal modulation scheme cannot be separated and an amount of a plurality of point frequencies in a triangular wave internal modulation scheme is low, and a problem that a frequency modulation bandwidth of a double-sideband modulation is limited, the present application provides a frequency-modulated continuous-wave laser radar ranging and speed measuring system, comprising:
a signal generation module, configured to provide an input laser signal in a first polarization state composed of a first laser signal, a second laser signal, a third laser signal and a fourth laser signal with different frequencies, wherein the first laser signal has a fixed frequency, the second laser signal is subjected by frequency modulation, the third laser signal and the fourth laser signal are generated based on the first laser signal and the second laser signal, both a frequency of the third laser signal and a frequency of the fourth laser signal have a corresponding relationship with a frequency of the first laser signal and a frequency of the second laser signal respectively, and an optical power of the first laser signal is different from an optical power of the second laser signal;
a silicon optical chip, configured to divide the input laser signal into a detection signal and a local oscillation signal, send out the detection signal, and receive an echo signal of a reflected signal component in a second polarization state orthogonal to a first polarization state in the reflected signal of the target object, then convert the echo signal in the second polarization state into the echo signal in the first polarization state, followed by performing a frequency mixing with the local oscillation signal to generate a beat frequency signal;
a signal processing module, configured to perform decoupling according to the beat frequency signal to obtain both distance information and instantaneous speed information of the target object.

The present application further provides a frequency-modulated continuous-wave laser radar ranging and speed measuring method.

The present application generates an input laser signal having four different frequency signals: the first frequency to the fourth frequency, while making three of the frequencies: the second frequency to the fourth frequency, carry a frequency modulation signal, i.e., a linear sawtooth wave modulation signal, so that after the echo signal and the local oscillation signal are beaten and output, at most four signal peaks on the frequency spectrum can be obtained. Thus, by analysing and determining the correspondence between the amount of the signal peaks and the signal intensity of each of the signal peaks, it is possible to achieve decoupling the detection distance and the speed in any cases, and improve a point frequency, as well as having a larger frequency modulation bandwidth than an ordinary FMCW radar system and a FMCW radar system taking a double sideband modulation scheme, therefore a smaller detection resolution can be achieved.

Specific embodiments of the present application are further described in detail below with reference to the accompanying drawings.

Referencing to FIG. 2, the present application provides a frequency-modulated continuous-wave laser radar ranging and speed measuring system, wherein the signal generation module comprises a light source module, an optical amplification module, and a nonlinear medium module. The silicon optical chip comprises a light splitting unit, a transceiving antenna unit, a polarization separation unit, a polarization rotation unit, an optical frequency mixing unit, and a photoelectric detection unit. Further, a trans-impedance amplification module is arranged between the silicon optical chip and the signal processing module.

In a plurality of embodiments, the light source module comprises two lasers including a first laser, i.e. a laser 1, and a second laser, i.e. a laser 2, configured to emit a first laser signal and a second laser signal at different frequencies, i.e. two laser beams of different frequencies. Wherein the first laser is configured to generate a first initial laser signal in a first polarization state having a first initial frequency f₁, and make no modulation to the first initial laser signal, so as to form a first initial laser signal in a TE polarization state having a first frequency f₁′ same as a fixed frequency of the first initial laser signal, that is, satisfying: f₁′=f₁. Wherein the TE polarization state is taken as the first polarization state, and a TM polarization state is taken as the second polarization state. The second laser is configured to generate a second initial laser signal in the TE polarization state having a second initial frequency f₂, and perform a linear sawtooth wave frequency modulation onto the second initial laser signal, so as to form a second initial laser signal in the TE polarization state having a second frequency f₂′ different to a modulated frequency of the second initial laser signal. A frequency having been modulated satisfies: f₂′=f₂+εt, ε is a frequency modulation slope, and is time.

An operating wavelength in the present application is not limited, and a typical wavelength is, for example, around 1550 nm.

The optical amplification module comprises a first fiber amplifier, i.e. EDFA 1 and a second fiber amplifier, i.e. EDFA 2. In an embodiment, the first fiber amplifier and the second fiber amplifier are both Erbium-doped fiber amplifiers, i.e. EDFA. Wherein the first optical fiber amplifier is configured to amplify a first laser signal, i.e. an output light beam, from the first laser, the second optical fiber amplifier is configured to amplify a second laser signal, i.e. an output light beam, from the second laser; an optical power P_{f1} corresponding to the first laser signal having been amplified and an optical power P_{f2} corresponding to the second laser signal having been amplified are both set in advance, satisfying: P_{f1}<p_{f2}, while a power difference between both is significant, and in an embodiment, a typical difference is more than 3 dB.

Also, it is possible to adopt a same EDFA to amplify the light beams emitted by both lasers.

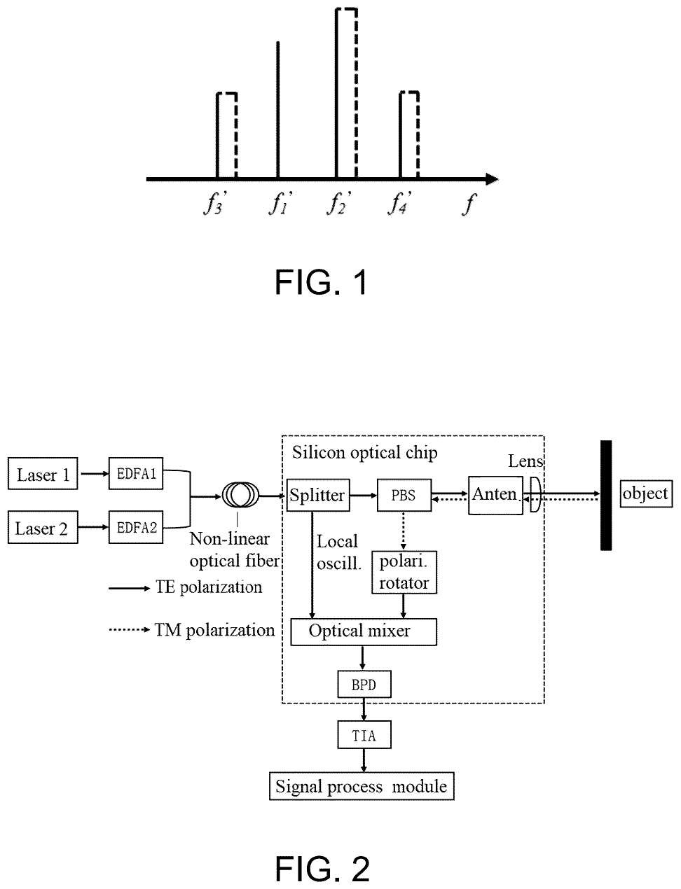

The nonlinear medium module comprises a highly nonlinear fiber. The first laser signal having been amplified and the second laser signal having been amplified are both input into the highly nonlinear fiber at a same time. Under a condition of phase-matching being met, due to a nonlinear effect in the highly nonlinear fiber, a FWM effect will be generated in the highly nonlinear fiber, so that the first laser signal, i.e. the first frequency, will interact with the second laser signal, i.e. the second frequency, and generate two new light beams with different frequencies additionally on a basis of two original frequencies, i.e. the first frequency and the second frequency. Thus, a third laser signal with a third frequency f₃′ and a fourth laser signal with a fourth frequency f₄′ are generated, shown as FIG. 1, wherein a horizontal coordinator represents a frequency f, so as to form an input laser signal containing 4 frequencies from the first frequency f₁′ to the fourth frequency f₄′, before being coupled to a silicon optical chip through the highly nonlinear fiber. Wherein the third frequency has a first correspondence with the first frequency and the second frequency, which satisfies: f₃′=2f₁′−f₂′=2f₁−f₂−εt, the fourth frequency has a second correspondence with the first frequency and the second frequency, which satisfies: f₄′=2f₂′−f₁′=2f₂−f₁+2εt.

In a plurality of embodiments, the highly nonlinear fiber and the silicon optical chip are coupled through an edge coupler, so as to couple efficiently the input laser signals generated in the optical fiber into the silicon optical chip.

It is also possible to adopt a method of lens coupling, to achieve a high-efficiency connection between the highly nonlinear fiber and the silicon optical chip.

Referencing to FIG. 2, in a plurality of embodiments, the light splitting unit in the silicon optical chip comprises an optical splitter; the transceiver antenna unit comprises a transceiver antenna and a collimating lens; the polarization separation unit comprises a polarization beam splitter (PBS); the polarization rotation unit comprises a polarization rotator; the optical mixing unit comprises an optical mixer; and the photoelectric detection unit comprises a balanced photodetector (BPD). The trans-impedance amplification module comprises a trans-impedance amplifier (TIA).

Wherein the optical splitter is configured to divide the input laser signal, i.e. the light beam, being coupled into the silicon optical chip into two parts according to a certain proportion, one part is used as a local oscillation light, i.e. the local oscillation signal, another part is used as a detection light, i.e. the detection signal. The optical splitter then inputs the detection signal to the polarization separator, and inputs the local oscillation signal to the optical mixer. In an embodiment, the optical splitter divides the input laser signal according to a beam splitting ratio of the detection signal greater than that of the local oscillation signal. In an embodiment, the beam splitter splits the input laser signal into the detection signal and the local oscillation signal at a beam splitting ratio of 90:10.

The PBS is configured to separate the detection signal and the echo signal to different paths, so as to obtain the echo signal. The detection signal is transmitted to the transceiving antenna through the PBS, without affecting a current polarized light. While the detection signal sent out by the transceiving antenna may be emitted to a free space for detection after having been collimated by a large-aperture collimating lens.

The transceiver antenna unit is configured to transmit the detection signal from the PBS to the free space, and receive an echo signal reflected from the target object. In particular, the transceiver antenna may be in a form of a grating antenna, an optical phased array, an optical waveguide based end-shot antenna, and more. Generally, a collimating lens needs to be added behind the antenna for transmission to reduce a degree of divergence of the light beam. In particular, if an antenna array is used to realize self-collimation of a light beam to be emitted, then it is not required for the collimating lens. The present application adopts an operation mode of integrating both emitting and receiving, that is, an emitting antenna is also used as a receiving antenna, i.e. an emitting/receiving coaxial antenna.

When a detection light beam encounters an object to be detected, i.e. the target object, both reflection and scattering will occur. Since a reflector usually has a certain depolarization action, thus, a reflected light beam or a scattered light beam comprises both an original TE polarized light and a TM polarized light orthogonal to the original TE polarized light, that is, after the detection light beam is reflected by the target object, in addition to an original polarization component, a component orthogonal to the original polarization component will also be generated. In the present application, a depolarized TM polarized light reflected signal component is received, and it is the waveguide antenna to receive and couple this part of the TM polarized light to the silicon optical chip to form the echo signal.

It is also possible to adopt a form of receiving and emitting by different axial. By separating the emitting antenna and the receiving antenna, the transmission of the detection signal and the reception of the echo signal are achieved independently.

Since the TM polarization state in the echo signal is orthogonal to the original TE polarization state, it will not return to an original path after passing through the PBS, instead, it will be transmitted to the polarization rotator. The polarization rotator is configured to convert the TM polarization state in the echo signal coming from the polarization separator into the TE polarization state with a same polarization as an emission signal, so that the echo signal and the local oscillation signal have a same TE polarization state, and enter the optical mixer.

The optical mixer is configured to mix a TE polarization state echo signal coming from the polarization rotator with a TE polarization state local oscillation signal to obtain the beat frequency signal. Four of the beat frequency signals being generated are then input to the balanced photoelectric detector to obtain the beat frequency current signal.

The trans-impedance amplifier is connected to the silicon optical chip, the beat frequency current signal generated by the balanced photoelectric detector in the silicon optical chip is applied as an input of the trans-impedance amplifier, the trans-impedance amplifier converts the beat frequency current signal into an amplified beat frequency voltage signal, and inputs into the signal processing module for decoupling. Finally, the beat frequency voltage signal is processed, analyzed and determined by the signal processing module, before generating the distance information and the instantaneous speed information of the target object. In FIG. 2, a transmission route of a TE polarization state signal is represented by a solid arrow, and a transmission route of a TM polarization state signal is represented by a dashed arrow.

According to the present application, by a four-wave mixing effect in the highly nonlinear fiber, a light beam containing four wavelength signals is generated and input into a silicon optical chip. And by applying a linear modulation to the light beam generated by the second laser, the light beam being input into the silicon optical chip comprises different frequency signals including three sawtooth wave linear modulated frequencies and a fixed frequency, that is, among four wavelengths being input, three wavelengths are carrying different linear modulation signal. Therefore, after beating and outputting frequencies of the echo signal and the local oscillation, a spectrum signal output by the signal processing module will comprise at most four signal peaks. By analyzing and determining the four signal peaks, it is possible to achieve a decoupling calculation for the distance and the speed of the target object to be detected in any cases.

In the present application, determining and processing a frequency domain signal output by frequency beating the echo signal and the local oscillation, is mainly based on an amount of the beat frequencies being generated and a corresponding intensity of a beat frequency signal at a different frequency.

The signal processing module, according to the beat frequency voltage signal, generates correspondingly a frequency spectrum signal containing at most four signal peaks, and by analyzing and determining a correlation between an amount of the signal peaks and a signal intensity of each signal peak, decoupling the distance and the speed of the target object in any case is achieved.

Further, when there are two signal peaks, the signal processing module determines that the target object is in a static state, and when there are four signal peaks, the signal processing module determines that the target object is in a moving state, and according to a correspondence between the signal intensities of the signal peaks, the signal processing module further determines that the target object is moving closer or further. Thus, according to a relationship between the frequencies of the signal peaks in different states and the beat frequency signal, a relationship between the Doppler frequency shift and the time of flight used for implementing distance measurement and speed measurement is obtained, so as to calculate and obtain the distance and the speed of the target object in any cases.

It is noted that, when the system of the present application works, a difference between two output frequencies of two lasers shall be specially designed. Typically, a difference between the second initial frequency and the first initial frequency is greater than 10 GHz, that is, satisfying f₂−f₁>10 GHz, further, a low-pass filter of 10 GHz may be added during a signal processing, so as to avoid detecting a mixing frequency between signals from different sources.

A frequency-modulated continuous-wave laser radar ranging and speed measurement method disclosed by the present application is further described in detail below, through specific embodiments and with reference to the accompanying drawings.

The present application further provides a method of ranging and speed measurement for a frequency-modulated continuous-wave laser radar, comprising:
providing an input laser signal in a first polarization state composed of a first laser signal, a second laser signal, a third laser signal and a fourth laser signal with different frequencies, wherein the first laser signal has a fixed frequency, the second laser signal is subjected by frequency modulation, the third laser signal and the fourth laser signal are generated based on the first laser signal and the second laser signal, both a frequency of the third laser signal and a frequency of the fourth laser signal have a corresponding relationship with a frequency of the first laser signal and a frequency of the second laser signal respectively, an optical power of the first laser signal is further different from an optical power of the second laser signal;
dividing the input laser signal into a detection signal and a local oscillation signal, sending out the detection signal, and receiving an echo signal of a reflected signal component in a TM polarization state orthogonal to a TE polarization state in the reflected signal of the target object, then converting the echo signal in the TM polarization state into the echo signal in the TE polarization state, followed by performing a frequency mixing with the local oscillation signal to generate a beat frequency signal;
performing decoupling according to the beat frequency signal to obtain both distance information and instantaneous speed information of the target object.

The method of ranging and speed measurement for the frequency-modulated continuous-wave laser radar can be implemented by using the frequency-modulated continuous-wave laser radar ranging and speed measuring system described above.

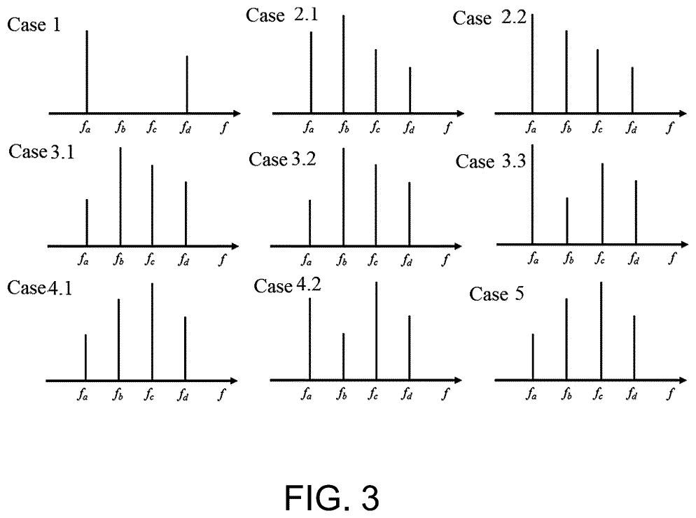

Referencing to FIG. 3, a figure corresponding to each case is a possible frequency spectrum distribution, wherein a horizontal coordinate represents a frequency f. In a plurality of embodiments, by the frequency-modulated continuous-wave laser radar ranging and speed measurement system according to the present application, and by a signal processing module, a correspondence between the amount of the signal peaks in the frequency spectrum being output and the signal intensity of each signal peak is analyzed and determined, specifically comprising:

A frequency spectrum produces at most four signal peaks. For convenience of expression, the four signal peaks are defined as: fₐ<f_{b}<f_{c}<f_{d} respectively, according to a magnitude of a frequency value, which are embodied in a plurality of spectral distribution patterns that may occur in each case in FIG. 3. Further, 4 signal intensities, or 4 signal amplitudes, corresponding to the four frequency values fₐ, f_{b}, f_{c}, and f_{d}, are defined as: Aₐ, A_{b}, A_{c}, and A_{d}, corresponding to 4 spectral vertical heights at four locations of the four frequency values fₐ, f_{b}, f_{c}, and f_{d} in FIG. 3.

The process of the system disclosed by the present application for decoupling the distance and the speed of the target object is described below, with reference to different states of the target object. Wherein a time of flight used for detecting the distance measurement and speed measurement is τ, the ranging frequency shift is f_{R}, and the Doppler frequency shift is f_{D}; while the decoupling is performed according to different states of the target object in the following 1) to 5):
1) when the target object is in the static state, after the time τ, a first echo frequency f₁″, a second echo frequency f₂″, a third echo frequency f₃″ and a fourth echo frequency f₄″ in the echo signal corresponding sequentially to the first frequency f₁′, the second frequency f₂′, the third frequency f₃′, and the fourth frequency f₄′, satisfying:

$${f}_{1}^{″} = {f}_{1} ,$$

$${f}_{2}^{″} = {f}_{2} + ε ( t - τ ) = {f}_{2} + ε t - ετ ,$$

$${f}_{3}^{″} = 2 {f}_{1} - {f}_{2} - ε ( t - τ ) = 2 {f}_{1} - {f}_{2} - ε t + ετ ,$$

$${f}_{4}^{″} = 2 {f}_{2} - {f}_{1} + 2 ε ( t - τ ) = 2 {f}_{2} - {f}_{1} + 2 ε t - 2 ετ ;$$

thus, the beat frequency signal generated after mixing with the f₁′, f₂′, f₃′ and fₐ′ in the local oscillation signal is:

$$Δ {f}_{1} = 0 , Δ {f}_{2} = \vert - ετ \vert = {f}_{a} , Δ {f}_{3} = ε τ = {f}_{a} , Δ {f}_{4} = \vert - 2 ετ \vert = {f}_{d} ;$$

in such a state, two signal peaks fₐ and f_{d} will be generated in a spectrum and satisfying: τ=fₐ/ε, f_{d}=0.
2) in a normal distance, the target object is moving closer, when ετ>f_{D}, satisfying:

$${f}_{1}^{″} = {f}_{1} + {f}_{D} ,$$

$${f}_{2}^{″} = {f}_{2} + ε t - ε τ + {f}_{D} ,$$

$${f}_{3}^{″} = 2 {f}_{1} - {f}_{2} - ε t + ε τ + {f}_{D} ,$$

$${f}_{4}^{″} = 2 {f}_{2} - {f}_{1} + 2 ε t - 2 ε τ + {f}_{D} ;$$

$$Δ {f}_{1} = {f}_{D} , Δ {f}_{2} = ε τ - {f}_{D} , Δ {f}_{3} = ε τ + {f}_{D} , Δ {f}_{4} = 2 ε τ - {f}_{D} ;$$

according to four frequency differences stated above, when ετ>2f_{D}, satisfying:

$$Δ {f}_{1} = {f}_{D} = {f}_{a} , Δ {f}_{2} = ετ - {f}_{D} = {f}_{b} , Δ {f}_{3} = ετ + {f}_{D} = {f}_{c} , Δ {f}_{4} = 2 ετ - {f}_{D} = {f}_{d} ;$$

when f_{D}<ετ<2f_{D}, satisfying:

$$Δ {f}_{1} = {f}_{D} = {f}_{b} , Δ {f}_{2} = ε τ - {f}_{D} = {f}_{a} , Δ {f}_{3} = ε τ + {f}_{D} = {f}_{d} , Δ {f}_{4} = 2 ε τ - {f}_{D} = {f}_{c} ;$$

3) in a short distance, the target object is moving closer in a high speed, when ετ<f_{D}, satisfying:

$$Δ {f}_{1} = {f}_{D} , Δ {f}_{2} = {f}_{D} - ετ , Δ {f}_{3} = ε τ + {f}_{D} , Δ {f}_{4} = \vert 2 ετ - {f}_{D} \vert ;$$

according to four frequency differences stated above, when ετ<½f_{D}, satisfying:
Δf₁=f_{D}=f_{c}, Δf₂=f_{D}−ετ=f_{b}, Δf₃=ετ+f_{D}=f_{d}, Δf₄=f_{D}−2ετ=fₐ; shown as case 3.1 in FIG. 3.
When ½f_{D}<ετ<⅔f_{D}, satisfying:
Δf₁=f_{D}=f_{c}, Δf₂=f_{D}−ετ=f_{b}, Δf₃=ετ+f_{D}=f_{d}, Δf₄=2ετ−f_{D}=fₐ, shown as case 3.2 in FIG. 3
When ⅔f_{D}<ετ<f_{D}, satisfying:
Δf₁=f_{D}=f_{c}, Δf₂=f_{D}−ετ=fₐ, Δf₃=ετ+f_{D}=f_{d}, Δf₄=2ετ−f_{D}=f_{b}; shown as case 3.3 in FIG. 3.
4) In a normal distance, the target object is moving away, when ετ>f_{D}, satisfying:

$${f}_{1}^{″} = {f}_{1} - {f}_{D} , {f}_{2}^{″} = {f}_{2} + ε t - ετ - {f}_{D} , {f}_{3}^{″} = 2 {f}_{1} - {f}_{2} - ε t + ε τ - {f}_{D} , {f}_{4}^{″} = 2 {f}_{2} - {f}_{1} + 2 ε t - 2 ετ - {f}_{D} ; \\ Δ {f}_{1} = {f}_{D} , Δ {f}_{2} = ετ + {f}_{D} , Δ {f}_{3} = \vert ετ - {f}_{D} \vert , Δ {f}_{4} = 2 ετ + {f}_{D} .$$

According to four frequency differences stated above, when f_{D}<ετ<2f_{D}, satisfying:
Δf₁=f_{D}=f_{b}, Δf₂=f_{D}+ετ=f_{c}, Δf₃=ετ−f_{D}=fₐ, Δf₄=f_{D}+2ετ=f_{c}; shown as case 4.1 in FIG. 3.
when ετ>2f_{D}, satisfying:
Δf₁=f_{D}=fₐ, Δf₂=f_{D}+ετ=f_{c}, Δf₃=ετ−f_{D}=f_{b}, Δf₄=f_{D}+2ετ=f_{d}; shown as case 4.2 in FIG. 3.
5) in a short distance, the target object is moving away in a high speed, when ετ<f_{D}, satisfies:
Δf₁=f_{D}=f_{b}, Δf₂=f_{D}+ετ=f_{c}, Δf₃=f_{D}−ετ=fₐ, Δf₄=f_{D}+2ετ=fₐ; shown as the case 5 in FIG. 3

Since the third laser signal and the fourth laser signal are generated based on the first laser signal and the second laser signal, and the optical power of the first laser signal is less than the optical power of the second laser signal, that is, the first frequency f₁′ being fixed and provided by a dual laser source, and the second frequency f₂′ being modulated, are two pump sources for the third frequency f₃′ and the fourth frequency f₄′ being generated additionally by the four-wave mixing effect. Thus, between a power P_{f1} carried by the first frequency f₁′, a power P_{f2} carried by the second frequency f₂′, a power P_{f3} carried by the third frequency f₃′, and a power P_{f4} carried by the fourth frequency f₄′, which will all be coupled into the silicon optical chip, there is a relationship below:

$${P}_{{f 2}^{}} > {P}_{{f 1}^{}} > {P}_{f 3} , {P}_{{f 2}^{}} > {P}_{f 1} > {P}_{f 4} .$$

Thus, the signal intensities between four frequency difference signals Δf₁, Δf₂, Δf₃ and Δf₄ further satisfies:

$${A}_{Δ f 2} > {A}_{Δ f 1} > {A}_{Δ f 3} , {A}_{Δ f 2} > {A}_{Δ f 1} > {A}_{Δ f 4} .$$

Thus, it is possible to obtain a relationship of magnitude between the signal intensities of Aₐ, A_{b}, A_{c}, and A_{d}, that is, the spectrum of each case given in FIG. 3.

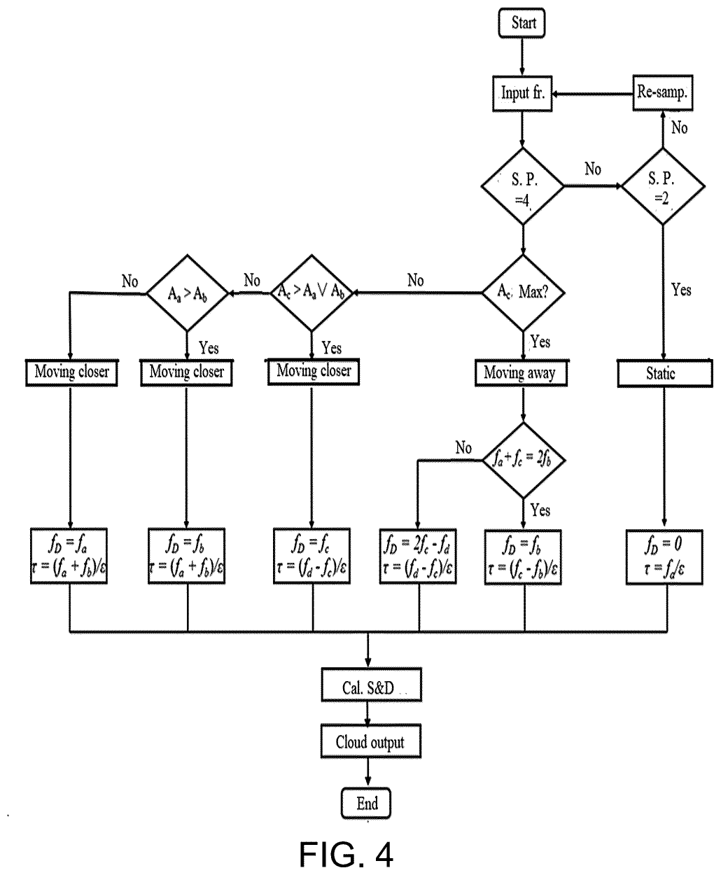

Based on the discussion for each case stated above, the present embodiment summarizes a determination rule for a frequency domain signal in a signal processing module, shown as FIG. 4. And following judgment results are obtained:

referencing to FIG. 4 and FIG. 3, a judgement is started when a spectrum is input. First, whether the amount of the signal peaks is 4 shall be determined, and when it is determined that the amount is not 4, then whether the amount of the signal peaks is 2 will be continued to determine, and when it is determined that the amount of the signal peaks is 2, the target object will be determined to be in a static state. In this case, according to the 1) stated above, it obtains:

$${f}_{D} = 0 , τ = {f}_{a} / ε .$$

Otherwise, when it is determined that the amount of the signal peaks is 4, then whether A_{c} is a maximum shall be determined, and when it is determined that it is the maximum, then it is determined that the target object is in a motion state of moving away. In this case, according to the 4) and 5) stated above, it shall be continuously determined whether fₐ+f_{c}=2f_{b} is satisfied, and when it is determined that fₐ+f_{c}=2f_{b} is satisfied, then it obtains:

$${f}_{D} = {f}_{b} , τ = ( {f}_{c} - {f}_{b} ) / ε .$$

While it is determined that fₐ+f_{c}=2f_{b} is not satisfied, then it obtains:

$${f}_{D} = 2 {f}_{c} - {f}_{d} , τ = ( {f}_{d} - {f}_{c} ) / ε .$$

When the amount of the signal peak is determined as 4, and A_{c} is determined not the maximum, then continue to determine if A_{c}>Aₐ or A_{b} is satisfied or not, and if it is determined to be yes, the target object is judged to be moving closer, that is, the target object is in a motion state of approaching, then according to 2) and 3), it obtains:

$${f}_{D} = {f}_{c} , τ = ( {f}_{d} - {f}_{c} ) / ε .$$

Otherwise, when judging if A_{c}>Aₐ or A_{b}, and it is determined to be no, continue to judge if Aₐ>A_{b} is satisfied or not, when it is determined as yes, the target object is in a motion state of moving closer, or in a motion state of approaching, according to 2) and 3), it obtains:

$${f}_{D} = {f}_{b} , τ = ( {f}_{a} + {f}_{b} ) / ε .$$

When judging if Aₐ>A_{b} is satisfied, and it is determined as no, the target object is moving closer, according to 2) and 3), it obtains:

$${f}_{D} = {f}_{a} , τ = ( {f}_{a} + {f}_{b} ) / ε .$$

Therefore, according to f_{D} and τ obtained respectively under various conditions stated above, it is possible to calculate and obtain the distance and the speed of the target object, and perform a point cloud output, so as to complete a whole analysis and judgment process.

Specifically, when an extremely special case occurs, such as ετ=f_{D}, and ετ=½f_{D}, since these states may occur only in a certain transient state, thus, when an amount of a plurality of spectrum beat frequency signals is not 4 or 2, that is, when the amount of the signal peaks is determined not 4 or 2, the system will automatically re-sample a spectrum at a next moment until the frequency spectrum has four or two signal peaks appeared, then adopt the determination rule stated above and perform a second analysis and determination process. Therefore, by adopting the determination rule stated above, it is possible to achieve decoupling the distance and the speed of the target object in any cases.

All above, the present application generates an input laser signal having four different frequency signals, from the first frequency to the fourth frequency, while making the second frequency to the fourth frequency carry a linear sawtooth wave modulation signal, so that after the echo signal and the local oscillation signal are beaten and output, at most four signal peaks on the frequency spectrum can be obtained. Thus, by analysing and determining the correspondence between the amount of the signal peaks and the signal intensity of each of the signal peaks, it is possible to achieve decoupling calculation of the distance and the speed of the target object. Further, four different frequency signals are generated according to the FWM, so that a solution freedom degree is increased. Compared with the scheme of triangular wave internal modulation, the technical solution disclosed in the present application is possible to achieve decoupling the detection distance and the speed in any cases, and by adopting a frequency sweeping form of the linear sawtooth wave, a point frequency can be improved, thus, a problem in an existing FMCW internal modulation scheme has been effectively solved, including the ranging frequency shift and the Doppler frequency shift cannot be separated, and the point frequency is low in the triangular wave internal modulation scheme. In addition, the third frequency and the fourth frequency of two additional linear modulation generated by the FWM have a larger frequency modulation bandwidth than an ordinary FMCW radar system and a FMCW radar system taking a double sideband modulation scheme, therefore a smaller detection resolution can be achieved.

While the embodiments of the present application have been described in detail above, it will be apparent to those skilled in the art that various modifications and variations can be made to the embodiments. It should be understood, however, that such modifications and variations are within the scope and spirit of the present application as set forth in the claims. Moreover, the present application described herein is capable of other embodiments and of being practiced or of being carried out in various ways.

What is claimed is:

1. A frequency-modulated continuous-wave laser radar ranging and speed measuring system, comprising:
a signal generation module, configured to provide an input laser signal in a first polarization state composed of a first laser signal, a second laser signal, a third laser signal and a fourth laser signal with different frequencies, wherein the first laser signal has a fixed frequency, the second laser signal is subjected by frequency modulation, the third laser signal and the fourth laser signal are generated based on the first laser signal and the second laser signal, both a frequency of the third laser signal and a frequency of the fourth laser signal have a corresponding relationship with a frequency of the first laser signal and a frequency of the second laser signal respectively, and an optical power of the first laser signal is different from an optical power of the second laser signal;
a silicon optical chip, configured to divide the input laser signal into a detection signal and a local oscillation signal, send out the detection signal, and receive an echo signal of a reflected signal component in a second polarization state orthogonal to a first polarization state in the reflected signal of the target object, then convert the echo signal in the second polarization state into the echo signal in the first polarization state, followed by performing a frequency mixing with the local oscillation signal to generate a beat frequency signal; and
a signal processing module, configured to perform decoupling according to the beat frequency signal to obtain both distance information and instantaneous speed information of the target object.

2. The system according to claim 1, wherein the signal generation module comprises a light source module, an optical amplification module and a nonlinear medium module,
wherein
the light source module is configured to transmit the first laser signal and the second laser signal with different frequencies,
the first laser signal has a first frequency fixed to a first initial frequency without modulation,
the second laser signal has a second frequency generated by performing a linear sawtooth wave frequency modulation onto a second initial frequency,
the optical amplification module is configured to amplify the first laser signal and the second laser signal before inputting into the nonlinear medium module, while ensuring an optical power of the first laser signal having been amplified less than that of the second laser signal having been amplified,
the nonlinear medium module is configured to make the first laser signal and the second laser signal have an interaction happened, and generating a third laser signal having a third frequency and a fourth laser signal having a fourth frequency based on a four-wave mixing effect, so as to form the input laser signal before coupling to the silicon optical chip,
wherein the third frequency has a first correspondence with the first frequency and the second frequency, while the fourth frequency has a second correspondence with the first frequency and the second frequency.

3. The system according to claim 2, further comprising: a trans-impedance amplification module,
wherein the silicon optical chip comprises a light splitting unit, a transceiving antenna unit, a polarization separation unit, a polarization rotation unit, an optical frequency mixing unit, and a photoelectric detection unit,
the light splitting unit is configured to divide the input laser signal being coupled to the silicon optical chip into the detection signal and the local oscillation signal, then input respectively to the polarization separation unit and the optical frequency mixing unit, while ensuing a beam splitting ratio of the detection signal larger than that of the local oscillation signal,
the transceiving antenna unit is configured to send the detection signal coming from the polarization separation unit out to a free space, and receive the echo signal reflected from the target object,
the polarization separation unit is configured to separate the detection signal and the echo signal,
the polarization rotation unit is configured to convert the echo signal in the second polarization state coming from the polarization separation unit into the echo signal in the first polarization state, so that both the echo signal and the local oscillation signal have same of the first polarization state,
the optical mixing unit is configured to mix the echo signal coming from the polarization rotation unit with the local oscillation signal, input four of the beat frequency signals being generated to the photoelectric detection unit to further obtain a beat frequency current signal, and
the trans-impedance amplification module is configured to further convert the beat frequency current signal having been input into a beat frequency voltage signal having been amplified, and input into the signal processing module for decoupling, so as to obtain the distance information and the instantaneous speed information of the target object.

4. The system according to claim 3, wherein the signal processing module generates correspondingly a spectrum signal containing at most four signal peaks according to the beat frequency voltage signal, analyzes and determines a correspondence between an amount of the signal peaks and a signal intensity of each of the signal peaks, so as to realize decoupling the distance and the speed of the target object in any cases.

5. The system according to claim 4, wherein when an amount of the signal peaks is two, the signal processing module determines that the target object is in a static state, and when the amount of the signal peaks is four, the signal processing module determines that the target object is in a motion state, and further determines if the target object is moving closer or moving away, according to a correspondence between the signal intensities of the signal peaks; thus, according to a corresponding relationship between the frequency of each signal peak and the beat frequency signal when the target object is in a different state, a relationship between a Doppler frequency shift of the target object and a time of flight used for implementing distance measurement and speed measurement is obtained, so as to calculate the distance and the speed of the target object in any case.

6. The system according to claim 2, wherein the light source module comprises a first laser and a second laser,
the first laser is configured to generate a first initial laser signal with the first initial frequency in the first polarization state, so as to form the first laser signal with a first frequency having a same fixed frequency as the first initial laser signal,
the second laser is configured to generate a second initial laser signal with a second initial frequency in the first polarization state, and performing a linear sawtooth wave frequency modulation onto the second initial laser signal to form a second laser signal with a second frequency having a modulated frequency different from the second initial laser signal,
the optical amplification module comprises an optical fiber amplifier, configured to amplify the first laser signal coming from the first laser and the second laser signal coming from the second laser, before inputting into the non-linear medium module at a same time, and
the non-linear medium module comprises a non-linear optical fiber, the non-linear optical fiber is coupled to the silicon optical chip through an edge coupler or a lens, so as to couple the input laser signal to the silicon optical chip.

7. The system according to claim 3, wherein
the light splitting unit comprises an optical splitter,
the transceiver antenna unit comprises a transceiver antenna and a collimating lens, the transceiver antenna comprises a grating antenna or an optical waveguide based end-fire antenna, or the transceiver antenna unit comprises an optical phased array,
the polarization separation unit comprises a polarization separator, wherein the polarization rotation unit comprises a polarization rotator,
the optical mixing unit comprises an optical mixer,
the photoelectric detection unit comprises a balanced photoelectric detector; and
the trans-impedance amplification module comprises a trans-impedance amplifier.

8. The system according to claim 3, wherein a difference between the optical power of the second laser signal and the optical power of the first laser signal is greater than 3 dB, and/or,
the input laser signal is divided into the detection signal and the local oscillation signal according to a beam splitting ratio of 90:10, and/or
a difference between the second initial frequency and the first initial frequency is greater than 10 GHz, and/or,
the first polarization state comprises a TE polarization state, while the second polarization state comprises a TM polarization state.

9. A method of ranging and speed measurement for a frequency-modulated continuous-wave laser radar, comprising:
providing an input laser signal in a first polarization state composed of a first laser signal, a second laser signal, a third laser signal and a fourth laser signal with different frequencies, wherein the first laser signal has a fixed frequency, the second laser signal is subjected by frequency modulation, the third laser signal and the fourth laser signal are generated based on the first laser signal and the second laser signal, both a frequency of the third laser signal and a frequency of the fourth laser signal have a corresponding relationship with a frequency of the first laser signal and a frequency of the second laser signal respectively, an optical power of the first laser signal is further different from an optical power of the second laser signal;
dividing the input laser signal into a detection signal and a local oscillation signal, sending out the detection signal, and receiving an echo signal of a reflected signal component in a second polarization state orthogonal to a first polarization state in the reflected signal of the target object, then converting the echo signal in the second polarization state into the echo signal in the first polarization state, followed by performing a frequency mixing with the local oscillation signal to generate a beat frequency signal;
performing decoupling according to the beat frequency signal to obtain both distance information and instantaneous speed information of the target object.

10. The method according to claim 9, wherein
the first laser signal of a first frequency f₁′ having a same fixed frequency as a first initial laser signal is formed by generating the first initial laser signal in the first polarization state having a first initial frequency f₁, and satisfying f₁′=f₁,
the second laser signal of a second frequency f₂′ having a different modulated frequency according to a second initial laser signal is formed by generating the second initial laser signal in the first polarization state having a second initial frequency f₂, and by performing a frequency linear sawtooth modulation on the second initial laser signal, and satisfying: f₂′=f₂+ετ, ε is a frequency modulation slope, t is time;
by amplifying both the first laser signal and the second laser signal before inputting into a nonlinear optical fiber synchronously, and ensuring an optical power of the first laser signal having been amplified less than that of the second laser signal having been amplified, the first laser signal and the second laser signal interact in the non-linear optical fiber, and generate a third laser signal having a third frequency f₃′ and a fourth laser signal having a fourth frequency f₄′ based on a four-wave mixing effect, so as to form the input laser signal, wherein the third frequency has a first correspondence with the first frequency and the second frequency, satisfying: f₃′=2f₁′−f₂′=2f₁−f₂−ετ, while the fourth frequency has a second correspondence with the first frequency and the second frequency, satisfying: f₄′=2f₂′−f₁′=2f₂−f₁+2ετ,
when dividing the input laser signal into the detection signal and the local oscillation signal, a beam splitting ratio of the detection signal is greater than a beam splitting ratio of the local oscillation signal.

11. The method according to claim 10, wherein
generate four of the beat frequency signals by mixing the echo signal with the local oscillation signal,
obtain the beat frequency current signal by performing photoelectric conversion on the beat frequency signal,
obtain an amplified beat frequency voltage signal by amplifying and converting the beat frequency current signal,
generate correspondingly a frequency spectrum signal containing at most four signal peaks by processing the beat frequency voltage signal, and
achieve decoupling the distance and the speed of the target object in any cases by analyzing and determining a correspondence between an amount of the signal peaks and a signal intensity of each signal peak.

12. The method according to claim 11, wherein while analyzing and determining the correspondence between the amount of the signal peaks and the signal intensity of each signal peak, when an amount of the signal peaks is two, the signal processing module determines that the target object is in a static state, and when the amount of the signal peaks is four, the signal processing module determines that the target object is in a motion state, and further determines if the target object is moving closer or moving away, according to a correspondence between the signal intensities of the signal peaks; thus, according to a corresponding relationship between the frequency of each signal peak and the beat frequency signal when the target object is in a different state, a relationship between a Doppler frequency shift of the target object and a time of flight used for implementing distance measurement and speed measurement is obtained, so as to calculate the distance and the speed of the target object in any case.

13. The method according to claim 12, wherein, analyzing and determining the correspondence between the amount of the signal peaks and the signal intensity of each signal peak, further comprising:
defining four of the signal peaks according to a frequency value, fₐ<f_{b}<f_{c}<f_{d}; and defining four signal intensities Aₐ, A_{b}, A_{c}, A_{d} according to the four frequency values fₐ, f_{b}, f_{c}, and f_{d}, defining a time of flight r used in measuring the distance and the speed, a ranging frequency shift f_{R}, and a Doppler frequency shift f_{b}; and performing decoupling according to 1)-5) below:
1) when the target object is in the static state, after the time t, a first echo frequency f₁″, a second echo frequency f₂″, a third echo frequency f₃″ and a fourth echo frequency f₄″ in the echo signal corresponding sequentially to the first frequency f₁′, the second frequency f₂′, the third frequency f₃′, and the fourth frequency f₄′, satisfying:
$${f}_{1}^{″} = {f}_{1} , {f}_{2}^{″} = {f}_{2} + ε ( t - τ ) = {f}_{2} + ε t - ε τ , {f}_{3}^{″} = 2 {f}_{1} - {f}_{2} - ε ( t - τ ) = 2 {f}_{1} - {f}_{2} - ε t + ε τ , {f}_{4}^{″} = 2 {f}_{2} - {f}_{1} + 2 ε ( t - τ ) = 2 {f}_{2} - {f}_{1} + 2 ε t - 2 ετ ;$$
thus, the beat frequency signal generated after mixing with the f₁′, f₂′, f₃′ and f₄′ in the local oscillation signal is:
$$Δ {f}_{1} = 0 , Δ {f}_{2} = \vert - ε τ \vert = {f}_{a} , Δ {f}_{3} = ε τ = {f}_{a} , Δ {f}_{4} = \vert - 2 ε τ \vert = {f}_{d} ;$$
in such a state, two signal peaks fₐ and fₐ are generated in a spectrum and satisfying: τ=fₐ/ε, f_{d}=0;
2) in a regular distance, when the target object is moving closer, ετ>f_{D}, satisfying:
$${f}_{1}^{″} = {f}_{1} + {f}_{D} , {f}_{2}^{″} = {f}_{2} + ε t - ε τ + {f}_{D} , {f}_{3}^{″} = 2 {f}_{1} - {f}_{2} - ε t + ε τ + {f}_{D} , {f}_{4}^{″} = 2 {f}_{2} - {f}_{1} + 2 ε t - 2 ε τ + {f}_{D} ; \\ Δ {f}_{1} = {f}_{D} , Δ {f}_{2} = ε τ - {f}_{D} , Δ {f}_{3} = ε τ + {f}_{D} , Δ {f}_{4} = 2 ε τ - {f}_{D} ;$$
when ετ>2f_{D}, satisfying:
$$Δ {f}_{1} = {f}_{D} = {f}_{a} , Δ {f}_{2} = ε τ - {f}_{D} = {f}_{b} , Δ {f}_{3} = ε τ + {f}_{D} = {f}_{c} , Δ {f}_{4} = 2 ε τ - {f}_{D} = {f}_{d} ;$$
when f_{D}<ετ<2f_{D}, satisfying:
$$Δ {f}_{1} = {f}_{D} = {f}_{b} , Δ {f}_{2} = ε τ - {f}_{D} = {f}_{a} , Δ {f}_{3} = ε τ + {f}_{D} = {f}_{d} , Δ {f}_{4} = 2 ε τ - {f}_{D} = {f}_{c} ;$$
3) in a short distance, when the target object is moving closer in a high speed, ετ<f_{D}, satisfying:
$$Δ {f}_{1} = {f}_{D} , Δ {f}_{2} = {f}_{D} - ετ , Δ {f}_{3} = ετ + {f}_{D} , Δ {f}_{4} = \vert 2 ετ - {f}_{D} \vert ;$$
when ετ<½f_{D}, satisfying:
$$Δ {f}_{1} = {f}_{D} = {f}_{c} , Δ {f}_{2} = {f}_{D} - ε τ = {f}_{b} , Δ {f}_{3} = ε τ + {f}_{D} = {f}_{d} , Δ {f}_{4} = {f}_{D} - 2 ε τ = {f}_{a} ;$$
when ½f_{D}<ετ<⅔f_{D}, satisfying:
$$Δ {f}_{1} = {f}_{D} = {f}_{c} , Δ {f}_{2} = {f}_{D} - ε τ = {f}_{b} , Δ {f}_{3} = ε τ + {f}_{D} = {f}_{d} , Δ {f}_{4} = 2 ε τ - {f}_{D} = {f}_{a} ;$$
when ⅔f_{D}<ετ<f_{D}, satisfying:
$$Δ {f}_{1} = {f}_{D} = {f}_{c} , Δ {f}_{2} = {f}_{D} - ε τ = {f}_{a} , Δ {f}_{3} = ε τ + {f}_{D} = {f}_{d} , Δ {f}_{4} = 2 ε τ - {f}_{D} = {f}_{b} ;$$
4) in a regular distance, when the target object is moving away, ετ>f_{D}, satisfying:
$${f}_{1}^{″} = {f}_{1} - {f}_{D} , {f}_{2}^{″} = {f}_{2} + ε t - ε τ - {f}_{D} , {f}_{3}^{″} = 2 {f}_{1} - {f}_{2} - ε t + ε τ - {f}_{D} , {f}_{4}^{″} = 2 {f}_{2} - {f}_{1} + 2 ε t - 2 ε τ - {f}_{D} ; \\ Δ {f}_{1} = {f}_{D} , Δ {f}_{2} = ε τ + {f}_{D} , Δ {f}_{3} = \vert ε τ - {f}_{D} \vert , Δ {f}_{4} = 2 ε τ + {f}_{D} ;$$
when f_{D}<ετ<2f_{D}, satisfying:
$$Δ {f}_{1} = {f}_{D} = {f}_{b} , Δ {f}_{2} = {f}_{D} + ε τ = {f}_{c} , Δ {f}_{3} = ε τ - {f}_{D} = {f}_{a} , Δ {f}_{4} = {f}_{D} + 2 ε τ = {f}_{c} ;$$
when ετ>2f_{D}, satisfying:
$$Δ {f}_{1} = {f}_{D} = {f}_{a} , Δ {f}_{2} = {f}_{D} + ε τ = {f}_{c} , Δ {f}_{3} = ε τ - {f}_{D} = {f}_{b} , Δ {f}_{4} = {f}_{D} + 2 ε τ = {f}_{d} ;$$
5) in a short distance, when the target object is moving away in a high speed, Στ<f_{D}, satisfying:
$$Δ {f}_{1} = {f}_{D} = {f}_{b} , Δ {f}_{2} = {f}_{D} + ε τ = {f}_{c} , Δ {f}_{3} = {f}_{D} - ε τ = {f}_{a} , Δ {f}_{4} = {f}_{D} + 2 ε τ = {f}_{d} ;$$
according to the third laser signal and the fourth laser signal being generated based on the first laser signal and the second laser signal, the optical power of the first laser signal less than the optical power of the second laser signal, a power P_{f1} carried by the first frequency f₁′, a power P_{f2} carried by the second frequency f₂′, a power P_{f3} carried by the third frequency f₃′, and a power P_{f4} carried by the fourth frequency f₄′, have a relationship below:
$${P}_{f 2} > {P}_{f 1} > {P}_{f 3} , {P}_{f 2} > {P}_{f 1} > {P}_{f 4} ;$$
the signal intensities between Δf₁, Δf₂, Δf₃ and Δf₄ further satisfying:
$${A}_{Δ f 2} > {A}_{Δ f 1} > {A}_{Δ f 3} , {A}_{Δ f 2} > {A}_{Δ f 1} > {A}_{Δ f 4} ;$$
so as to obtain a relationship of magnitude between the signal intensities of Aₐ, A_{b}, A_{c}, and A_{d}, and obtain a result below:
when an amount of the signal peak is determined as two, the target object is determined in a static state, and according to 1), it obtains:
$${f}_{D} = 0 , τ = {f}_{a} / ε ;$$
when an amount of the signal peak is determined as four, and A_{c} is determined a maximum, the target object is determined to be in the motion state of moving away, according to 4) and 5), when it satisfies fₐ+f_{c}=2f_{b}, obtaining:
$${f}_{D} = {f}_{b} , τ = ( {f}_{c} - {f}_{b} ) / ε ;$$
when it is determined that fₐ+f_{c}=2f_{b} is not satisfied, obtaining:
$${f}_{D} = 2 {f}_{c} - {f}_{d} , τ = ( {f}_{d} - {f}_{c} ) / ε ;$$
when the amount of the signal peak is determined as four, and A_{c} is determined not the maximum, but A_{c}>Aₐ or A_{b}, the target object is determined to be in the motion state of approaching, according to 2) and 3), obtaining:
$${f}_{D} = {f}_{c} , τ = ( {f}_{d} - {f}_{c} ) / ε ;$$
when the amount of the signal peak is determined as four, and A_{c} is determined not the maximum, while A_{c}>Aₐ or A_{b} is not satisfied, but Aₐ>A_{b} is satisfied, the target object is determined to be moving closer, according to 2) and 3), obtaining:
$${f}_{D} = {f}_{b} , τ = ( {f}_{a} + {f}_{b} ) / ε ;$$
when the amount of the signal peak is determined as four, and A_{c} is determined not the maximum, while A_{c}>Aₐ or A_{b} is not satisfied, and Aₐ>A_{b} is not satisfied either, the target object is determined to be in the motion state of approaching, according to 2) and 3), obtaining:
$${f}_{D} = {f}_{a} , τ = ( {f}_{a} + {f}_{b} ) / ε ;$$
calculating and obtaining the distance and the speed of the target object according to the f_{D} and τ stated above, and outputting as a point cloud.

14. The method according to claim 13, wherein when it is determined that the amount of the signal peaks is not four or two, a frequency spectrum at a next moment will be automatically re-sampled, until there are four or two signal peaks appearing in the frequency spectrum, then a second analysis and judgment process will be performed.
